(19) United States
(12) Patent Application Publication
(10) Pub. No.: US 2009/0019802 A1
(43) Pub. Date: Jan. 22, 2009

(54) Adjustable insulation containment apparatus

(76) Inventor: Theron L. Crall, JR., Oak Grove, MO (US)

Correspondence Address: LAW OFFICE OF JOHN C. MCMAHON, P.O. BOX 30069, KANSAS CITY, MO, 64112, US

(21) Appl. No.: 11/879,609

(22) Filed: Jul. 18, 2007

(51) Int. Cl. B29C 44/34

(52) U.S. Cl. 52/404.3

(57) ABSTRACT

An adjustable insulation containment apparatus for insulating about duct work having a plurality of foldable sections or members that can be selectively ganged together by connection to each other to make a run. The members can be adjusted for width of the conduit. Alternatively, the apparatus can be formed by a pair of scored planar sheets held in position by end panels and spacers.

### BACKGROUND OF THE INVENTION

The present invention is directed to an adjustable apparatus that can be readily assembled for placement about a ventilation duct in an attic or the like for containing insulation in a preferred configuration about the duct, and is adjustable to accommodate various configurations of ductwork.

Because energy is becoming an increasingly scarce and expensive resource for both the heating and cooling of houses and similar structures, it is becoming increasingly important to insulate such structures in such a manner so as to prevent significant loss of heating and cooling to the ambient air. Current recommended insulation guidelines typically call for an insulating factor in the R30 to R38 range. An insulating factor of R38 effectively equates to about 12 inches of blown cellulose or fiberglass insulation. Consequently, most modern houses are constructed with approximately 12 inches of insulation within the attic structure above the ceiling of the top floor.

In addition to energy lost through walls and ceilings, there can also be a substantial loss of energy through the ductwork that carries heating and/or cooling throughout a structure. In order to avoid such a loss, this ductwork is often placed beneath the ceiling or between a lowered artificial ceiling and the attic in such a structure. Nevertheless, many structures do not have sufficient clearance to place the ductwork in a protected location, and even when the ductwork can be placed below the ceiling, it is often aesthetically unpleasing.

Consequently, the ductwork is often placed in the attic, especially when no basement is present to carry it. When such ductwork is placed in an attic, it is usually placed over ceiling joists and is typically 6 inches or greater in diameter or thickness. When insulation is blown into the attic, it settles into the space between the joists and below the ductwork and only partially covers the ductwork. Consequently, it is desirable to also fully insulate the ductwork that is run through the attic with a 12-inch layer of insulation.

While it is desirable to provide a full layer of insulation for the ductwork, it would be prohibitively expensive to place an insulating blanket of sufficient thickness to provide 12 inches of insulation for the ductwork throughout the entire attic and it may also make it difficult to work in the attic for people needing access thereto. Therefore, it is desirable to provide a structure that retains additional insulation in the region immediately surrounding the ductwork so that the ductwork can have a proper insulating cover without spreading the insulation in a uniform layer throughout the attic.

Structures for containing insulation in this manner have previously taken the form of a fixed wall that is constructed with material such as boards and plywood and nailed to the ceiling joists to form a trough for the insulation covering the ductwork. While such a constructed wall is effective in maintaining the insulation, it has a major drawback in that it requires a substantial period of time, labor, and materials to construct. Most insulators are interested in maintaining labor costs as low as possible and wish to quickly apply the appropriate insulation coating to an attic.

Consequently, it is desirable to have an apparatus that utilizes relatively simple and inexpensive materials and includes component structures for accommodating different types, lengths, and configurations of ductwork to provide containment for insulation covering the ductwork.

### SUMMARY OF THE INVENTION

A containment apparatus is provided for use in conjunction with the insulation of ventilation ducts in attics and the like wherein the apparatus is readily and quickly assembled for holding or containing insulation in a surrounding relationship about the duct. In one embodiment the apparatus comprises a plurality of foldable members that form an adjustable insulation containment apparatus. Each member is folded to form three sides of a containment cell, and multiple members are slidably interlocked to form an elongate channel having a series of segmented compartments that can be filled to the top thereof with insulation.

The number of members used will depend on the length of the ductwork being insulated, thereby providing an apparatus that can accommodate essentially any typical configuration of ductwork. Preferably, the apparatus is constructed of a cardboard type of material wherein the corrugation of the members is generally vertically aligned to provide flexibility and allow bending about a vertical axis along the member.

During installation, the desired number of members can be quickly deployed to a fully expanded configuration and positioned over a duct, after which the apparatus is filled with insulation to provide suitable insulation for the duct. The members are formed to fold at selected positions to accommodate round ducts or different sizes of rectangular ducts. Scores or weakened areas are provided, so that portions of the members may also be removed to accommodate different sizes of rectangular ducts. Preferably, the apparatus is sized and shaped so that when installed and filled with insulation, it provides the duct with a desired insulation factor.

In an alternative embodiment, the adjustable channel is constructed from scored and folded foam sheeting which is unfolded to form elongate planar panels or sheets with end panels of the type described for the embodiment previously described above and held in place by crossing elements or spans.

### OBJECTS AND ADVANTAGES OF THE INVENTION

Therefore, the objects of the present invention are: to provide an insulation containment apparatus for holding insulation around and over a ventilation duct so as to provide a selected insulation factor for the ventilation duct; to provide such an apparatus that can be brought to a job site in a collapsed configuration and relatively quickly assembled and adjusted to an expanded configuration suitable for use in conjunction with such a ventilation duct; to provide such an apparatus that includes foldable and compact component members that can be interlocked to form the apparatus; to provide such an apparatus having component members that are easily modified by bending along prescored lines or removing along tear lines to accommodate varying sizes and types of ducts; to provide such an apparatus with side panels that can be constructed of cardboard, foam board, plastic, screen or the like that are suitable for use in building construction and relatively inexpensive in cost; to provide such an apparatus that can be relatively quickly installed; to provide such an apparatus that can be treated to improve fire resistant properties thereof; to provide such an apparatus that is relatively easy to manufacture and inexpensive to produce; to provide a method of use of the apparatus that allows relatively quick and simple construction of a containment apparatus for containing insulation around a duct within an attic or the like; and to provide such an apparatus and method that are particularly well adapted for the intended usage thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a fragmentary view of an insulation containment member removably joined with a second insulation containment member to form an adjustable insulation containment apparatus in accordance with the present invention shown positioned over a ventilation duct in an attic structure.

FIG. 2 is a fragmentary view of the adjustable insulation containment apparatus as adjusted to accommodate a ventilation duct that is rectangular in manufacture and showing an insulation containment member positioned to be joined with another insulation containment member.

FIG. 3 is side view of an insulation containment member of the adjustable insulation containment apparatus.

FIG. 4 is a fragmentary and enlarged side view of two insulation containment members being joined together to form the adjustable insulation containment apparatus.

FIG. 5 is a fragmentary view of the adjustable insulation containment apparatus being filled with insulation.

FIG. 6 is a perspective view on a reduced scale of an insulation containment member in a folded state.

FIG. 7 is a modified embodiment of the adjustable insulation containment apparatus in accordance with the present invention shown positioned over a ventilation duct in an attic structure.

FIG. 8 is an enlarged and fragmentary view of the modified containment apparatus showing a wall joined to a rafter.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The reference numeral 1 generally represents an adjustable insulation containment apparatus in accordance with the present invention, which is shown in FIGS. 1 and 5 in a building attic 2 and covering a circular heating and air conditioning ventilation duct 3.

The attic 2 includes a series of spaced and parallel wooden beams or ceiling joists 10 to which is attached a ceiling 11 of an upper floor of a structure supporting the attic 2. The joists 10 have top surfaces 12 supporting the ventilation duct 3. The ceiling 11 includes a layer of sheet rock 11. As is shown in FIG. 5, an insulation blanket 15 is installed in the attic 2. The insulation blanket 15 is positioned on top of the sheet rock 13 and the joists 10 so that the insulation 15, when completely installed, forms a generally uniform layer of insulation across the entire ceiling 11. Preferably, the insulation blanket has an overall depth of at least 12 inches relative to the top of the sheet rock 13 and may be constructed of blown cellulose, fiberglass, or the like when fully installed.

The heating and air conditioning duct 3 is a conventional type of ductwork utilized in houses and other types of building construction. The duct 3 is constructed of conventional 6-inch diameter aluminum tubing and is shown as an elongate relatively straight horizontal duct run 18. The duct run 18 is shown extending generally perpendicular to the joist 10 and rests on the top of the joist 10 so as to extend thereabove. It is noted that in accordance with the present invention, the containment apparatus 1 can be modified for different types of duct, for example square or rectangular duct. The containment apparatus 1 can also be modified in accordance with the present invention to accommodate ducts having various widths and heights as will be discussed with respect to the embodiments discussed below.

The insulation containment apparatus 1 includes multiple elongate containment members 20 that may be folded to form an end panel 21 and opposing side panels 22 and 23. The insulation containment apparatus 1 is assembled by joining two or more containment members 20 together as shown in FIGS. 1 and 5, to receive and retain the insulation as it is installed.

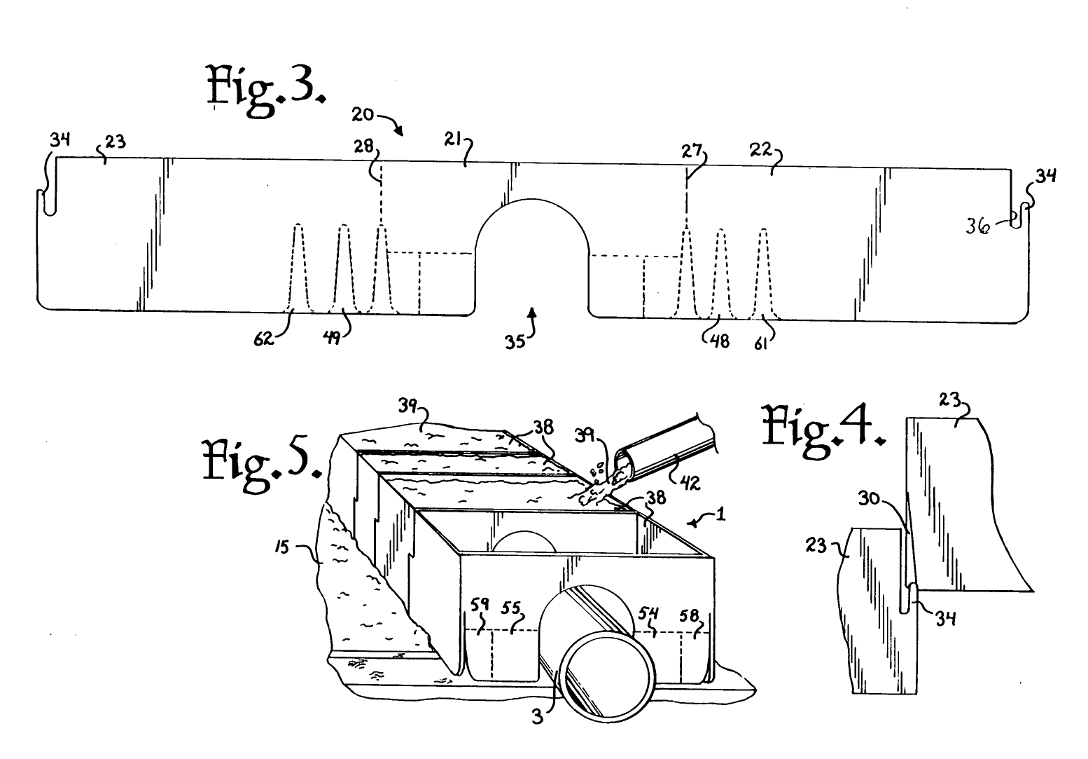

Prior to use, the containment members 20 are elongate and planar as shown in FIG. 3. Preferably the containment members 20 are constructed so as to provide a desired height of insulation above a particular duct 3. The containment members 20 shown in FIG. 1 are approximately 14 inches tall to retain about 12 inches of insulation 15 above the joists 10, thereby insulating the duct run 18. It is foreseen that other sizes of containment members 20 could be utilized depending upon the desired insulation level or duct size. The containment members 20 are illustrated to be about 6 feet long, with each end panel 21 and side panel 22 and 23 being about 2 feet long. The 2-foot width of end panel 21 provides room for enough insulation to adequately insulate the duct 3.

The end panel 21 and opposing side panels 22 and 23 are formed when a containment member 20 is folded along lines of weakness or score lines 27 and 28 that extend upward from notches 30 and 31 formed when selectively removable strips 32 and 33 are detached from their respective side panels 22 and 23. In production, the score lines may be perforations in the cardboard material from which the containment member 20 is made. The primary purpose of the notches 30 and 31 is to facilitate mating of one containment member 20 with another containment member 20 as the insulation containment apparatus 1 is assembled over a duct run 18.

Each end of containment member 20 is formed with a hook 34 that defines a channel 36 for receiving a corresponding notch 30 or 31 in a second containment member 20, as illustrated in FIG. 4. Thus, once the containment member 20 is folded, it can be removably secured, or ganged, to another containment member 20 by mating the hook 34 of the other containment member 20 into the notches 30 and 31 of the first containment. In continuing fashion, a multiplicity of insulation containment members 20 may be assembled to form the adjustable insulation containment apparatus 1. The number of containment members 20 required for a particular containment apparatus 1 will depend on the length of the duct run 18.

The containment members 20, when in use for containing insulation 39 rest upon the joist tops 12 in the attic 2. Each containment member 20 has an arch-shaped opening 35 sized so as to fit over the duct 3 as the insulation containment members 20 are assembled over the duct run 18. Once the required number of insulation containment members 20 are placed over the duct run 18, the insulation containment apparatus 1 is assembled. As is shown in FIG. 5, the insulation containment apparatus 1 comprises various compartments 38 that are formed as the containment members 20 are joined. The compartments 38 of the apparatus 1 are filled with insulation 39, such as by blowing the insulation 39 from a tube 42 attached to a conventional insulation blowing apparatus (not shown).

In the preferred embodiment, the containment members 20 are highly flexible and constructed of a relatively thick cardboard. The cardboard is corrugated to facilitate folding along score lines 27 and 28. While the illustrated embodiment utilizes cardboard for constructing the containment members 20, it is foreseen that other materials of construction such as plastic could be utilized for this purpose.

Generally, the containment members 20 should be lightweight and relatively long-lived in an attic environment. When the containment members 20 are constructed of cardboard or other flammable material, they may be treated with a fire retardant to reduce the likelihood of combustion.

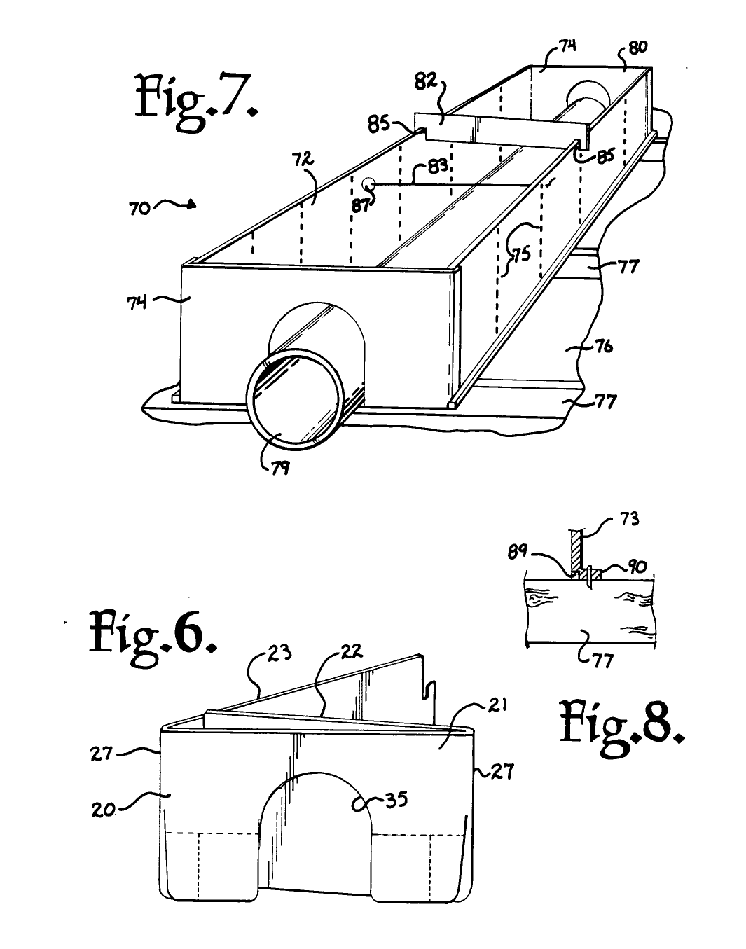

Shown in FIG. 6 is the containment member 20 in a folded state. For transport and storage, the containment members 20 may be laid flat, or folded for ease of transport or storage. The containment member 20 may be bent or folded at the vertical score lines 27 that define the end panel 21 and the side panels 22 and 23, with the side panels 22 and 23 then being folded inwardly, as is shown in FIG. 6. In the folded state, the containment member 20 takes up relatively little space and can be easily moved about by an installer.

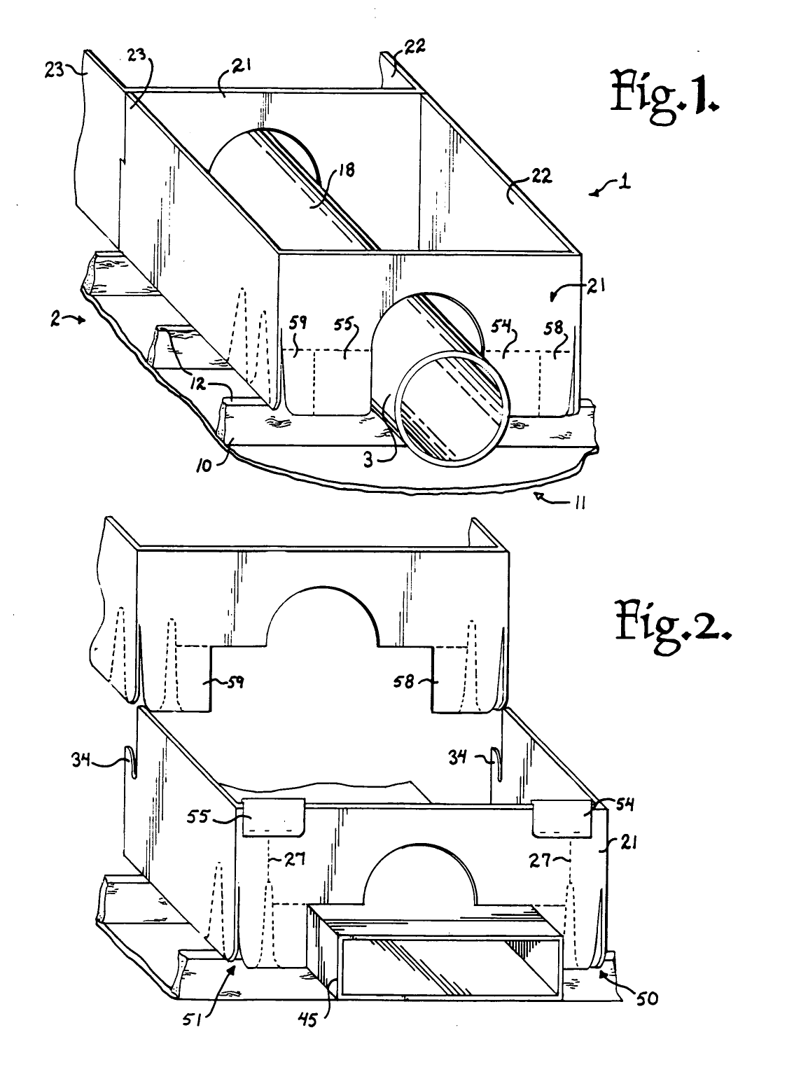

Illustrated in FIG. 2, the insulation containment apparatus 1 is adjustable to accommodate different sizes and shapes, such as a rectangular ventilation duct 45. In practice, it is common for rectangular ventilation ducts 45 to be about 10 inches high and 18 or 24 inches wide. The containment member 20 has removable strips 48 and 49 form notches 50 and 51 when removed. The containment member 20 is folded at notches 50 and 51, thereby increasing the width of end panel 21 to allow receipt of the rectangular ventilation duct 45. The primary purpose of the notches 50 and 51 is to facilitate mating of one containment member 20 with another containment member 20 as the insulation containment apparatus 1 is assembled over a duct run 18.

To accommodate the depth and increased width of the ventilation duct 45, each containment member 20 has detachable tabs 54 and 55. The end panel 21 is lightly scored to allow relatively easy detachment of tabs 54 and 55 to allow the containment member 20 to fit over the ventilation duct 45.

Because the containment member 20 is scored along lines 27 and 28, it is easily folded therealong and it may be desirable to reinforce the end panel 21 so it does not fold along lines 27 and 28 when rectangular ventilation ducts 45 is being insulated. Accordingly, the detachable tabs 54 and 55 may be attached, as by stapling, at the top of the end panel 21 at score lines 27 and 28, as illustrated in FIG. 2. When so attached, the detachable tabs 54 and 55 reinforce end panel 21 along score lines 27 and 28, thereby increasing its structural integrity.

The containment members 20 are constructed to accommodate rectangular ventilation ducts that are wider than illustrated in FIG. 2. Each containment member 20 has secondary detachable tabs 58 and 59 for this purpose. When such secondary detachable tabs 58 and 59 are removed, a wider ventilation duct (not shown) can be accommodated and insulated by the insulation containment apparatus 1.

The containment member 20 has removable strips 61 and 62, which form notches when removed. The containment member 20 is folded at the notches formed by removing strips 61 and 62, thereby increasing the width of end panel 21 to allow receipt of the wider (such as 24-inch) rectangular ventilation duct. The primary purpose of the notches formed by detaching strips 61 and 62 is to facilitate mating of one containment member 20 with another containment member 20 as the insulation containment apparatus 1 is assembled over a duct run.

Illustrated in FIG. 7 is a second embodiment of an adjustable insulation containment apparatus according to the present invention generally represented by the reference numeral 70. The apparatus 70 is in many respects similar to the apparatus 1 and description of common features will not be repeated in detail herein. The apparatus 70 includes a pair of elongate side panels 72 and 73 that are formed by unfolding a scored and folded sheet and that in use are spaced by spacer end panels 74, placed at either end of the apparatus 70. In this manner the side panes 72 and 73 have a plurality of vertical scores 75 equally spaced therealong. Additional spacer panels 74 may be placed along the spacer panels 74. The spacer panels 74 are attached at opposite sides thereof to the side panels 72 and 73 and extend from an intermediate vertical location along the side panels 72 and 73 to the tops of the side panels 72 and 73.

The apparatus 70 is shown in an attic structure 76 positioned on a series of equally spaced ceiling joists 77. Running between the side panels 72 and 73 and beneath the spacer panels 74 is a ventilation duct 79. The apparatus 70 forms one or more compartments 80 about the duct 79 to hold insulation (not shown), as is illustrated with respect to the apparatus 1. In the embodiment illustrated in FIG. 7, the side panels 72 and 73 are relatively flexible and constructed of a relatively thick foam board, preferably of approximately three eights of an inch in thickness.

The apparatus 70 may include alternative spacing means, such as spacing member 82 and spacing wire 83. The elongate spacing member 82 is formed with slots 85 for receiving the tops of opposing side panels 72 and 73. The slots 85 are spaced so as to hold the side panels 72 and 73 apart at a distance approximating the width of spacer panels 74. In the embodiment illustrated in FIG. 7, the spacing member 82 is constructed of a relatively thick foam board.

Also shown in FIG. 7 is the spacing wire 83, which also serves to maintain spacing of side panels 72 and 73. The side panels 72 and 73 have opposing receiving holes through which the spacing wire 83 runs. The spacing wire 83 runs through a keeper 87 that is placed on the wire 83 in the space between the side panels 72 and 73. The keeper 87 allows the spacing between the side panels 72 and 73 to be adjusted to the desired distance.

Because of the need for adjustability and configuration of certain attics or because it is desirable to secure the apparatus 70 in a fixed location for certain reasons, the side panels 72 and 73 may be formed near the base thereof with a notch 89, which allows the side panels 72 and 73 to be secured to floor joists 77. When in use, as illustrated in FIG. 8, the side panels 72 and 73 are stapled at the base 90 to one or more of the floor joists 77. In use, the apparatus 70 is filled with insulation to the top thereof to insulate the duct 79 as has been described for the previous embodiment.

It is to be understood that while certain forms of the present invention have been illustrated and described herein, it is not to be limited to the specific forms or arrangement of parts described and shown.

What is claimed and desired to be secured by Letters Patent is as follows:

1. An adjustable insulation containment apparatus for insulating ductwork, said apparatus comprising:
(a) a plurality of elongate containment members, each of which is foldable and mateable with other containment members to form a plurality of rectangular insulation containment areas therebetween;
(b) each containment member forming an end panel and two opposing side panels when folded with the side panels generally perpendicular to the end panel;
(c) passage structural located on the lower end of the end panel to allow for passage of the ductwork therethrough.

2. The apparatus according to claim 1 including connecting structure on each containment member for connecting a second containment wherein the connecting structure includes:
(a) ganging structure located at the end of each side panel; and
(b) notches formed at the juncture of each side panel with the end panel for receiving said ganging structure to join containment members to form said adjustable insulation containment apparatus.

3. The apparatus according to claim 2 wherein the ganging structure is hooks formed into the ends of said side panels.

4. The apparatus according to claim 1 wherein the passage structure located on the lower end of the end panel forms an arch to allow passage of circular ductwork therethrough.

5. The apparatus according to claim 1 wherein said containment members are adjustable to increase the width of said end panels to accommodate different sizes and shapes of ductwork.

6. The apparatus according to claim 5 wherein said end panels include structural tabs that are selectively removable to accommodate different sizes and shapes of ductwork.

7. The apparatus according to claim 1 wherein said containment members are constructed of cardboard having corrugations that are vertically aligned during use to allow easy folding thereof.

8. A method of insulating about a duct in an attic comprising the steps of:
(a) preforming a plurality of containment members that are folded for transport and unfolded and mated with one another to form an adjustable insulation containment apparatus;
(b) placing said containment members over said duct to form said insulation containment apparatus; and
(c) filling said compartment with insulation.

9. An insulation containment apparatus for insulating ductwork comprising:
(a) a pair of scored elongate flexible side panels;
(b) a pair of end panels; each of said end panels being attached at opposite ends thereof to said side panels, with said end panels being attached at opposite ends of said side panels; and
(c) a plurality of spacers attached at opposite ends thereof to said side panels at spaced locations therealong so as to form at least one compartment for containing insulation between said side panels and between said end panels.

10. The apparatus according to claim 9 wherein said spacers are solid spacing members containing slots at opposite ends thereof for placement over opposing side panels.

11. The apparatus according to claim 9 wherein said spacers are wires attached to opposing side panels.

12. The apparatus according to claim 9 including notches formed along a lower end of said side panels wherein said notches allow said lower end of said side panels to be folded into horizontal contact and secured to floor joists upon which said apparatus rests.
